(19) United States
(12) Patent Application Publication
(10) Pub. No.: US 2026/0117819 A1
(43) Pub. Date: Apr. 30, 2026

(54) BEARING ARRANGEMENT FOR A WIND TURBINE

(71) Applicants: ZF FRIEDRICHSHAFEN AG, Friedrichshafen (DE); ZF Wind Power Antwerpen N.V., Lommel (BE)

(72) Inventor: Arno KLEIN-HITPASS, Aachen (DE)

(21) Appl. No.: 19/372,333

(22) Filed: Oct. 29, 2025

(30) Foreign Application Priority Data
Oct. 30, 2024 (DE) 10 2024 210 469.8

(51) Int. Cl. F16C 19/36; F16C 19/18

(52) U.S. Cl. CPC F16C 19/364; F16C 19/181; F16C 2360/31

(57) ABSTRACT

A bearing arrangement for a wind turbine for supporting a drivetrain on a tower of the wind turbine includes a base plate which is attachable to the tower and has a main bearing section for rotatably supporting a rotor shaft of the drivetrain and for supporting forces of the rotor shaft. The main bearing section introduces radial forces relative to a rotor shaft axis into the base plate and allows axial displacements along the rotor shaft axis. The radial forces have components in a transverse and a vertical direction. A bearing housing receives and supports parts of the drivetrain, and a torsion bearing unit supports a torsional moment about the rotor shaft axis, which is applied to the bearing housing by the drivetrain. The torsion bearing unit introduces axial forces in the direction of the rotor shaft axis and torsional moments about the rotor shaft axis into the base plate.

### CROSS REFERENCE TO RELATED APPLICATIONS

This application claims benefit to German Patent Application No. DE 10 2024 210 469.8, filed on Oct. 30, 2024, which is hereby incorporated by reference herein.

### FIELD

The present disclosure relates to a bearing arrangement for a wind turbine. The present disclosure further relates to a wind turbine with a bearing arrangement.

### BACKGROUND

Wind turbines are known which serve to generate electricity from wind energy by conversion. For conversion, such turbines are equipped with a rotor configured to convert wind energy into mechanical power, for example into a rotation with a torque. The torque generated in this way can be introduced into a drivetrain in order to be converted into electrical power, for example by a generator. In view of the high weights and forces that occur, for example, in large wind turbines with an output capacity of several megawatts, high demands are placed on the support of the drivetrain in terms of load capacity and force introduction. Due to these high demands, conventionally solid housings with high rigidity are used to absorb and support all forces of the drivetrain, which can result in a high weight.

### SUMMARY

In an embodiment, the present disclosure provides a bearing arrangement for a wind turbine for supporting a drivetrain on a tower of the wind turbine. The bearing arrangement includes a base plate which is attachable to the tower and has a main bearing section for rotatably supporting a rotor shaft of the drivetrain and for supporting forces of the rotor shaft. The bearing arrangement also includes a bearing housing for receiving and supporting parts of the drivetrain, and a torsion bearing unit for supporting a torsional moment about a rotor shaft axis applied by the drivetrain to the bearing housing. The main bearing section is configured to introduce radial forces into the base plate with respect to the rotor shaft axis and to allow axial displacements along the rotor shaft axis. The radial forces have components in a transverse direction and components in a vertical direction, and the torsion bearing unit is configured to introduce axial forces in a direction of the rotor shaft axis and torsional moments about the rotor shaft axis into the base plate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a wind turbine with a drivetrain, according to an embodiment of the present disclosure;

FIG. 2 illustrates a basic principle for supporting forces and torques of the wind turbine of FIG. 1, according to an embodiment of the present disclosure;

FIG. 3 illustrates the deflection of a rotor shaft of the wind turbine of FIG. 1, according to an embodiment of the present disclosure;

FIG. 4 schematically shows a bearing arrangement according to the basic principle of FIG. 2, according to an embodiment of the present disclosure;

FIG. 5 schematically shows a base plate of the bearing arrangement of FIG. 4, according to an embodiment of the present disclosure;

FIG. 6 schematically shows a bearing arrangement according to a first embodiment of the present disclosure in a lateral sectional view along a rotor shaft axis;

FIG. 7 is a schematic sectional view of the bearing arrangement of FIG. 6, according to an embodiment of the present disclosure;

FIG. 8 is an illustration of the disassembly of a connecting device of the bearing arrangement of FIG. 6 and FIG. 7, according to an embodiment of the present disclosure;

FIG. 9 is a schematic cross-sectional view of a bearing arrangement according to a second embodiment of the present disclosure;

FIG. 10 is a schematic cross-sectional view of a bearing arrangement according to a third embodiment of the present disclosure;

FIG. 11 is an illustration of the disassembly of a connecting device of the bearing arrangement of FIG. 10, according to an embodiment of the present disclosure;

FIG. 12 is a schematic cross-sectional view of a bearing arrangement according to a fourth embodiment of the present disclosure;

FIG. 13 is an illustration of the disassembly of a connecting device of the bearing arrangement of FIG. 12, according to an embodiment of the present disclosure; and

FIG. 14 schematically shows a bearing arrangement according to a fifth embodiment of the present disclosure in a side sectional view along the rotor shaft axis.

### DETAILED DESCRIPTION

A first aspect of the present disclosure relates to a bearing arrangement for a wind turbine for supporting a drivetrain on a tower of the wind turbine. The wind turbine may have a rotor. The rotor may be configured to convert wind energy into rotational mechanical energy and to introduce this energy into the drivetrain. The wind turbine may comprise a tower and a nacelle, which accommodates and supports at least parts of the drivetrain. The nacelle may be attached to an upper end of the tower. The nacelle may be rotatably attached to the tower. The nacelle may be rotatable about a vertical yaw axis in order to perform a yaw movement of the nacelle relative to the tower. The wind turbine may have a yaw bearing to provide the yaw movement. The yaw movement may serve to align the nacelle or the drivetrain in a horizontal plane relative to the wind, for example to achieve a desired pitch angle with respect to the wind direction. A lower end of the tower may be anchored to a base. Alternatively, the lower end of the tower may be attached to an offshore wind turbine platform.

The drivetrain may comprise a generator for converting wind energy into electrical energy. The rotor may, for example, be connected to the generator via a rotor shaft of the drivetrain. The rotor may comprise several rotor blades, for example three rotor blades. The drivetrain may comprise a hub via which the rotor is coupled to the rotor shaft. The hub may be configured to adjust a pitch angle of the rotor blades. The drivetrain may have a gearbox which is arranged in a torque flow between the rotor and the generator. The generator may be configured to use the rotation of the rotor shaft or the rotation of an output of the gearbox for power generation. The gearbox may be configured to convert a rotational speed of the rotor shaft into another, for example higher, rotational speed for driving the generator. The rotational speed of the rotor shaft during operation can be, for example, between 2 rpm and 30 rpm, for example between 5 rpm and 20 rpm. The rotational speed for driving the generator during operation can be, for example, between 500 rpm and 3000 rpm, for example between 900 rpm and 2000 rpm. A drive of the gearbox can be mechanically operatively connected to the rotor, and the output of the gearbox can, for example, be mechanically operatively connected to the generator. The gearbox can be configured to transmit a torque from the rotor shaft to the generator. The drivetrain may also have auxiliary units. The auxiliary units may be configured to influence parameters of the rest of the drivetrain and physical variables of the wind turbine. The auxiliary units may comprise, for example, a heating system, a cooling system, an alignment system for the nacelle, an adjustment system for the hub, and/or converter systems, for example inverters, for the generated electrical energy.

The bearing arrangement may be configured to support at least some of the kinematic degrees of freedom of the drivetrain. The kinematic degrees of freedom may comprise three displacements and three rotations. The bearing arrangement may be configured to support one, several, or all degrees of freedom of the drivetrain or parts thereof. Depending on the configuration of the bearing arrangement, a further bearing arrangement may be provided which locks remaining degrees of freedom and/or supports parts of the drivetrain that are not supported by the bearing arrangement. In principle, it may be necessary to constrain five of the six degrees of freedom of the rotor shaft in order to operate the wind turbine. One rotational degree of freedom of the rotor shaft can remain free during operation to enable a rotation of the rotor shaft and the associated initiation of torque for energy generation. The rotation of the rotor shaft may cause a reaction torque in the generator. The reaction torque in the generator can be supported by the bearing arrangement. The drivetrain may also have a braking device that can slow down the rotation of the rotor shaft, for example in case of strong winds or for maintenance work.

The bearing arrangement has a base plate that can be attached to the tower. The base plate can be rotatably supported on the tower, for example directly on the tower or indirectly via a yaw bearing. The base plate can be configured to provide connection points for the bearing arrangement for force introduction and/or torque introduction. The connection points may comprise rigid connections and/or articulated connections. The base plate may, for example, be configured as an at least partially annular element. The base plate may also be configured as a shell element. The base plate may have a passage for the rotor shaft at a rotor-side end.

The base plate has a main bearing section for rotatably supporting a rotor shaft of the drivetrain and for supporting forces of the rotor shaft. The main bearing section can be arranged at a rotor-side end section of the nacelle, for example, near the hub. The main bearing section can be formed integrally with the base plate or can be attached thereto. The main bearing section can have a main bearing which rotatably supports the rotor shaft.

The main bearing section is configured to transmit radial forces relative to a rotor shaft axis into the base plate. The rotor shaft axis can be a center axis of the rotor shaft. Under certain circumstances, the rotor shaft axis may not be straight, but may follow a bend in the rotor shaft. The radial forces of the rotor shaft may comprise, for example, a weight force of the rotor, the weight force of the rotor shaft, and/or operating forces due to the rotation of the rotor shaft. The radial forces have components in a transverse direction and components in a vertical direction. The transverse direction can be a direction that is perpendicular to the rotor shaft axis and essentially horizontal. The vertical direction may be a direction that is perpendicular to the rotor shaft axis and perpendicular to the transverse direction or to a transverse axis. For example, the rotor shaft axis, a vertical axis, and a transverse axis may have a common origin at the center of the main bearing section or the main bearing and form a right-handed Cartesian coordinate system. The main bearing section may also be configured to introduce pitch moments into the base plate about an axis extending in the transverse direction. The main bearing section may further be configured to introduce yaw moments into the base plate about an axis extending in a vertical direction. The rotor shaft axis may run substantially horizontally when the rotor shaft is unloaded. Alternatively, the rotor shaft axis may be arranged at an angle to the horizontal. For example, a rotor-side end of the rotor shaft may be arranged higher than a generator-side end. When loaded, the rotor shaft may bend, wherein the rotor shaft axis follows the bend of the rotor shaft. The main bearing section is further configured to allow axial displacements along the rotor shaft axis. For example, the main bearing may be configured as a pure radial bearing, for example as a cylindrical friction bearing.

The bearing arrangement has a bearing housing for receiving and supporting parts of the drivetrain. The bearing housing may be configured to accommodate and support only parts of the drivetrain or also the entire drivetrain. For example, the bearing housing may support only the gearbox, only the generator, or both the gearbox and the generator. The bearing housing may also be configured to support rotatable elements. The rotatable elements may, for example, comprise the rotor shaft or transmission elements such as gear wheels. The parts and/or rotatable elements accommodated and supported in the bearing housing can introduce forces and/or moments into the bearing housing.

The bearing arrangement has a torsion bearing unit for supporting a torsional moment about the rotor shaft axis, which is applied to the bearing housing by the drivetrain. The torsion bearing unit may, for example, comprise a coupling element for converting the torsional moment about the rotor shaft axis, which is applied to the bearing housing by the drivetrain, into a force acting in the vertical direction. The torsional moment may, for example, be a reaction moment of the generator and/or the gearbox to a drive moment of the rotor shaft. The torsion bearing unit may be configured to convert the torsional moment about the rotor shaft axis into the force acting in the vertical direction by means of a geometric arrangement that includes a lever arm between the rotor shaft axis and a line of action of the force acting in the vertical direction. The torsion bearing unit may be configured as a torque support which introduces the torsional moment outside the rotor shaft axis as a force into the base plate. The torsion bearing unit can be configured as a rigid element which is attached to the bearing housing and/or to the base plate. The torsion bearing unit can also be configured integrally with the bearing housing.

The torsion bearing unit is configured to introduce axial forces in the direction of the rotor shaft axis and torsional moments about the rotor shaft axis into the base plate. The torsion bearing unit may also be configured to introduce other forces, such as weight forces and forces that are not supported by the main bearing section, into the base plate. When a force or moment is introduced, this means that a degree of freedom associated with the force or moment is blocked. Consequently, introducing a force in one direction means that displacement in that direction is essentially prevented. Similarly, introducing a torque means that rotation about the torque axis is essentially prevented.

With the bearing arrangement according to the first aspect a bearing arrangement is provided that provides two separate force introduction paths for loads from the rotor shaft to the base plate. One force introduction path leads via the main bearing section to the base plate and serves to support radial forces. Another force introduction path leads via the bearing housing and the torsion bearing unit to the base plate and serves to support axial forces and torsional moments of the rotor shaft on the base plate. By separating the force introduction paths depending on the load to be transmitted, each force introduction path can be better matched to the underlying load. For example, it is possible to adjust stiffnesses depending on the direction. For example, stiffnesses in the direction of a load can be maximized and stiffnesses transverse to the direction of the load can be minimized. Naturally, stiffness is provided by the targeted use of materials. With the bearing arrangement of the first aspect, the use of materials can therefore be optimized in view of the loads. As a result, the bearing arrangement of the first aspect achieves high stiffnesses while keeping weight low.

In one embodiment, the base plate has a support section. The support section is configured to support the torsion bearing unit so that it can rotate about a support axis running in the transverse direction. The bearing housing can be attached to the torsion bearing unit. The bearing housing can also be formed integrally with the torsion bearing unit. The rotatable supporting of the torsion bearing unit about the support axis allows the composite of the torsion bearing unit and the bearing housing to follow any bending of the rotor shaft. Thus, it is not necessary to apply bearing loads that counteract the bending of the rotor shaft. Accordingly, the use of materials can be further optimized. This results in a lightweight bearing arrangement.

In one embodiment, the torsion bearing unit for supporting the rotor shaft has an angled bearing arrangement with two radial-axial bearings, which transmit radial and axial forces respectively. Depending on their structural shape, bearings can generally be divided into radial bearings, which only absorb radial forces, axial bearings, which only absorb axial forces, and radial-axial bearings, which absorb both radial and axial forces. Regardless of the structural shape, at least one of the bearings can be configured as a rolling bearing. Similarly, at least one of the bearings can be configured as a friction bearing. The angled bearing arrangement can be one in which axial forces in one direction are supported only by one of the radial-axial bearings and axial forces in the other direction are supported only by the other radial-axial bearing. This can be achieved, for example, by two angular contact ball bearings or tapered roller bearings arranged in a mirror image. Force flow lines through the bearings can form an X arrangement or an O arrangement. In the O arrangement, extensions of the force flow lines can intersect the rotor shaft axis outside the bearing points. In the X arrangement, the force flow lines can intersect the rotor shaft axis between the bearing points. In both cases, the angled bearing arrangement provides a lightweight, simple, and cost-effective means of absorbing large forces and torques as well as of better accommodating bending through the torsion bearing unit.

In one embodiment, the torsion bearing unit for supporting the rotor shaft has a radial-axial bearing and a separate radial bearing. This allows a compact and lightweight structure to be achieved. In addition, assembly advantages can be achieved.

In one embodiment, the torsion bearing unit for supporting the rotor shaft has a radial bearing and a separate axial bearing. This allows for a simple and lightweight structure. In addition, with such a bearing arrangement, the radial forces and axial forces can also follow different force introduction paths within the torsion bearing unit. This allows for further optimization of material usage. The axial bearing can be formed around the entire circumference of the rotor shaft axis. In a further embodiment, the axial bearing can be formed only in sections along the circumference. This reduces the usage of material and the weight.

In one embodiment, the torsion bearing unit for supporting the rotor shaft has a further radial bearing, and the radial bearing and the further radial bearing are arranged symmetrically around the support axis. This achieves uniform force introduction into the torsion bearing unit. The radial bearing and the additional radial bearing can be of similar size. This means that for the same load two smaller bearings can be used instead of one large bearing. If identical bearings are used, this also reduces costs. In an alternative configuration, the further radial bearing can be larger or smaller than the radial bearing, for example if the load is asymmetrical.

In one embodiment, the torsion bearing unit for supporting the rotor shaft has a further radial bearing, and the further radial bearing is spaced further from the support axis than the radial bearing. In such a case, the further radial bearing can primarily serve to align the torsion bearing unit along the bending line of the rotor shaft and absorb only minor radial forces from the rotor shaft. Then, the further radial bearing can be very small in size. For example, the radial bearing can be dimensioned to absorb the entire pitch moments of the rotor shaft, and the further radial bearing can be dimensioned for introducing only a force sufficient to align the torsion bearing unit and the bearing housing.

In one embodiment, the radial bearing is configured as a rolling bearing and the axial bearing as a friction bearing. Such a hybrid bearing arrangement provides a simple and cost-effective structure.

In one embodiment, the bearing arrangement has a connecting device. The connecting device has a rotor shaft section and a gearbox section. The rotor shaft section can be connected to the rotor shaft in a rotationally fixed manner. The gearbox section can be connected to a gearbox of the drivetrain in a rotationally fixed manner. If the drivetrain does not have a gearbox, the gearbox section can instead be connectable to a generator. The connecting device can be configured to provide a mechanical operative connection between the rotor shaft and further drivetrain components. The rotor shaft section and the gearbox section can be detachably connected to each other. The connecting device allows the rotor shaft and the gearbox or the rest of the drivetrain to be easily decoupled from each other. This reduces maintenance costs. In addition, the connecting section allows the rotor shaft and the remaining drivetrain components to be dimensioned independently of each other. This allows the dimensions of the parts to be better adapted to different load conditions and general conditions. This results in a low-weight bearing arrangement.

In one embodiment, at least one of the rotor shaft section and the gearbox section is arranged in a force flow for introducing axial forces from the rotor shaft into the torsion bearing unit. For example, the connecting section can be configured in a disk-shaped manner and can provide a bearing surface for an axial bearing. Alternatively or additionally, the connecting section may be of cylindrical shape and provide a bearing surface for a radial bearing. Providing the connecting section also for force introduction further reduces the amount of material usage.

In one embodiment, the torsion bearing unit has a lubricant reservoir. The lubricant reservoir can be configured to hold lubricant for the gearbox, other drivetrain components, and/or any auxiliary units. The lubricant reservoir can be sealed to the outside and provided with connections for any connecting lines. The lubricant reservoir may also be configured to accommodate a separate lubricant container. In such a case, through holes for connecting lines may be provided for this purpose. The integration of the lubricant reservoir makes otherwise unused volume in the torsion bearing unit usable, thereby achieving functional standardization and, consequently, further weight reduction.

In one embodiment, the base plate is configured as a shell element that essentially follows a cylindrical surface. For example, the shell element may have a plane bottom surface that can be attachable to the tower. The shell element can extend upward from the plane bottom surface as may be required. For example, different heights of the shell element can provide the main bearing section and/or the support section. The surface of the shell element may deviate from the cylindrical surface, for example to provide reinforcing struts or local thickenings.

The shell element may be divisible along one or more dividing lines. Parts of the shell element can be permanently or detachably joined together along the dividing lines. For example, dividing lines can be provided which divide the main bearing section into several sub-sections. Such dividing lines can pass through a center point of a main bearing, which is accommodated in the main bearing section, and extend substantially horizontally. Alternatively or additionally, dividing lines can run horizontally below the main bearing. Further dividing lines may run substantially vertically, for example to simplify the manufacture and/or transport of the shell element. The joining of the shell elements may take place at a manufacturing site for the shell element or at an installation site for the wind turbine. Joining may be carried out, for example, by form-fitting, by joining methods, or by friction-locking. For example, joining can be carried out by welding and/or screwing. If the base plate configured as a shell element has a support section, one or more recesses, for example bore holes, can be formed below this. This allows an effective stiffness of the support section to be adjusted when absorbing forces from the torsion bearing unit.

A second aspect of the present disclosure relates to a wind turbine with the bearing arrangement according to the first aspect. The wind turbine may, for example, be configured for power generation. The wind turbine has a drivetrain, a tower, and the bearing arrangement of the first aspect. The bearing arrangement is attached at a tip of the tower. For example, a base plate of the bearing arrangement may be attached at the tip of the tower via a yaw bearing. Respective advantages and further features can be found in the description of the first aspect, whereby embodiments of the first aspect also form embodiments of the second aspect and vice versa.

In one embodiment, a force introduction point for introducing forces from the torsion bearing unit into the base plate overlaps a tip-side wall of the tower in the vertical direction. As a result, forces from the torsion bearing unit are introduced into the tower along a short path and with high stiffness. Thus, through a simple structure material usage and weight are minimized.

In one embodiment, the drivetrain has a rotor with at least two rotor blades and a generator. The rotor is mechanically operatively connected to the generator via the rotor shaft. In one embodiment, the drivetrain has a gearbox that is arranged in a torque flow between the rotor shaft and the generator.

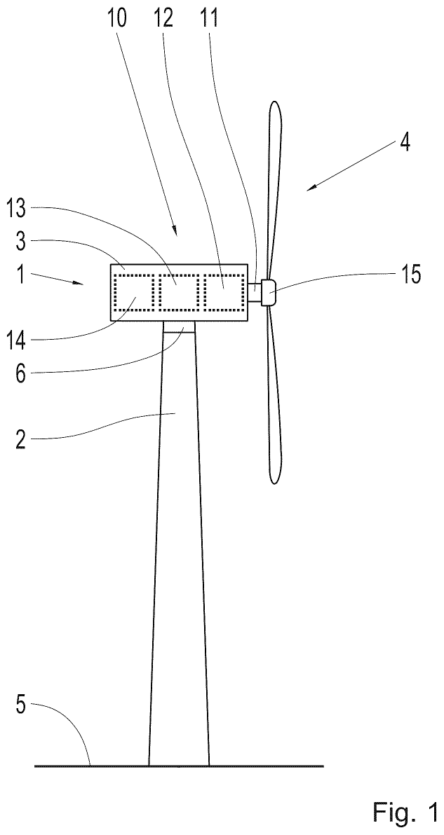

FIG. 1 schematically illustrates a wind turbine 1 in horizontal construction. The wind turbine 1 has a nacelle 3 which is rotatably attached to an upper end of a tower 2 via a yaw bearing 6. A lower end of the tower 2 is anchored to a base 5. The nacelle 3 accommodates a drivetrain 10, which comprises a rotor shaft 11, a gearbox 12, a generator 13, auxiliary units 14, and a hub 15. A rotor 4 of the wind turbine 1 is mechanically operatively connected to the generator 13 via the hub 15, the rotor shaft 11, and the gearbox 12. The auxiliary units 14 may comprise devices for temperature control of the drivetrain 10, devices for converting electrical power, devices for adjusting the hub 15, and devices for aligning the nacelle 3 via the yaw bearing 6. The wind turbine 1 further has a bearing arrangement for supporting parts of the drivetrain 10.

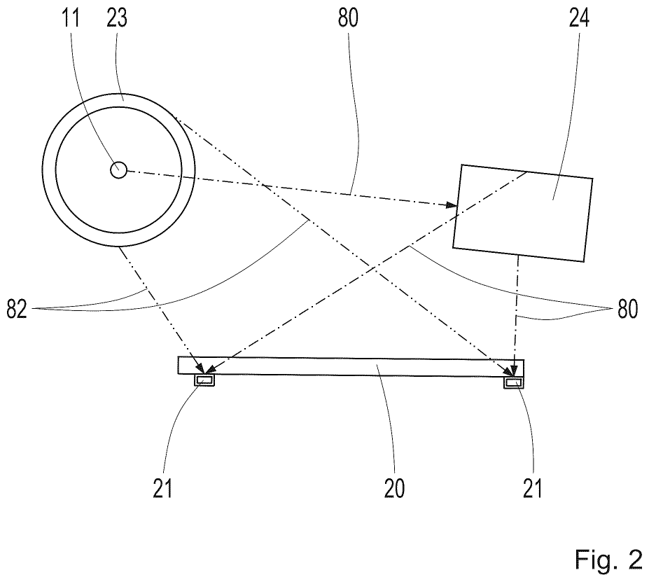

FIG. 2 illustrates a basic principle for supporting forces and torques in the wind turbine 1. The wind turbine 1 has the drivetrain 10 with the rotor shaft 11. Via the rotor 4, forces and torques are introduced into the rotor shaft 11. These forces and torques can include, for example, a torsional moment about a rotor shaft axis 70 of the rotor shaft 11 and further rotor shaft loads. The further rotor shaft loads can include, for example, axial and radial forces as well as torques about a yaw axis and about a transverse axis. The present disclosure provides for two separate paths for supporting these forces and torques, as illustrated in principle in FIG. 2. The rotor shaft 11 is supported by a main bearing 23. The main bearing 23 is configured to freely allow at least a rotation of the rotor shaft 11 and to absorb some or all of the other rotor shaft loads. The other rotor shaft loads absorbed by the main bearing 23 are introduced via a support 82 into a base plate 20, which is attached to the tower 2 via one or more base plate bearings 21. The torsional moment from the rotor shaft 11, on the other hand, is supported on a bearing housing 24. The bearing housing 24 is supported on the base plate 20 to transmit the torsional moment, so that a support 80 of the torsional moment is carried out via the bearing housing 24 and the base plate 20 on the base plate bearings 21. This basic principle provides a separation of the paths for supporting the torsional moment and the further rotor shaft loads. It should be noted that some of the further rotor shaft loads can also be supported via the bearing housing 24 on the base plate 20. An example of such support is described later with reference to the embodiments.

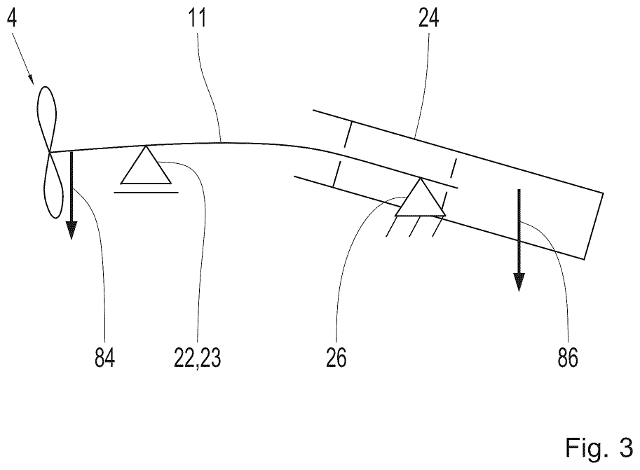

FIG. 3 schematically shows a deflection of the rotor shaft 11 of the wind turbine 1. The rotor shaft 11 is supported on the side of the rotor 4 by the main bearing 23 and a main bearing section 22 described later. On the side of the bearing housing 24, the rotor shaft 11 is supported by a support section 26 described later. Under the influence of gravity, a weight force 84 of the rotor 4 and a weight force 86 of the bearing housing 24 and the components accommodated therein act on the rotor shaft 11. Under the influence of these weight forces 84, 86, the rotor shaft 11 can bend in the direction of gravity, which is exaggeratedly shown in FIG. 3. The present disclosure provides for the bearing arrangement of the embodiments described in detail below to enable the bearing housing 24 to follow the deflection of the shaft 11 in order to reduce the reaction forces to be supported.

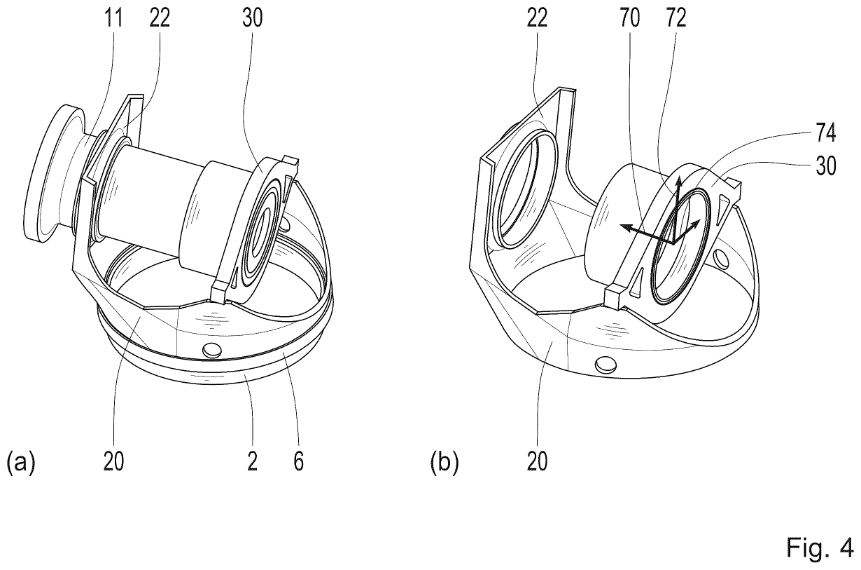

FIG. 4 schematically shows a bearing arrangement based on the basic principle of FIG. 2. In an area (a) on the left side of FIG. 4, the tower 2, the yaw bearing 6, the base plate 20, a torsion bearing unit 30, and the rotor shaft 11 are shown. The rotor shaft 11 is rotatably supported in the main bearing section 22. The torsion bearing unit 30 is configured to support the torsional moment. Furthermore, the bearing housing 24, which is not shown in FIG. 4, is attached to the torsion bearing unit 30. In an area (b) on the right-hand side of FIG. 4, all components except the base plate 20 and the torsion bearing unit 30 are hidden in order to enable a better illustration of the following direction definitions. A rotor shaft axis 70 follows a center axis of the rotor shaft 11. A transverse direction 74 runs horizontally and perpendicular to the rotor shaft axis 70. A vertical direction 72 runs perpendicular to the rotor shaft axis 70 and the transverse direction 74. In FIG. 4, coordinate axes in the vertical direction 72 and the transverse direction 74 are shown with a common origin at the rotor shaft axis 70 to represent a Cartesian coordinate system. Nevertheless, references to the vertical direction 72 and the transverse direction 74 in the following description refer to location-independent directional information, unless a specific location is named.

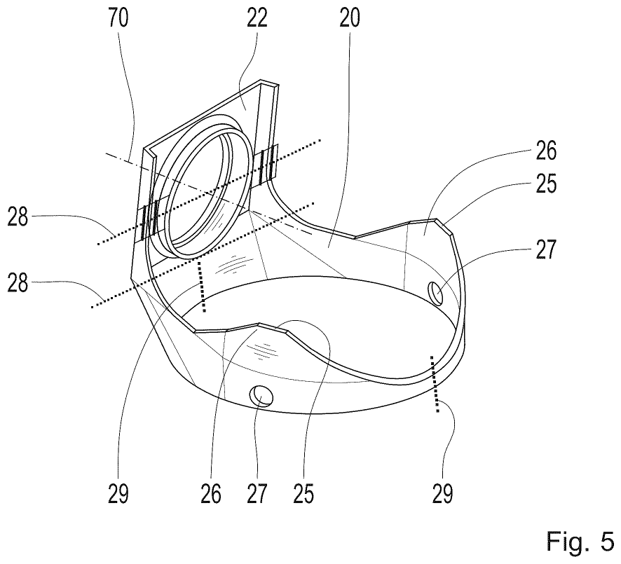

FIG. 5 shows a schematic representation of the base plate 20 from FIG. 4. The base plate 20 is configured as a shell element that essentially follows a cylindrical surface. More specifically, the base plate 20 has a plane bottom surface from which thin-walled structures extend upward in an essentially cylindrical manner. The thin-walled structures extend to different heights. This forms the main bearing section 22 and the support section 26. A receptacle for the main bearing 23 is formed on the main bearing section 22 in the form of a cylindrical through bore with a cylindrical inner surface. Two support sections 26 are formed on both sides of the rotor shaft axis 70. Below each of the support sections 26, a recess 27 is formed, which serves to adjust the stiffness of the support section 26. The recess 27 is formed as a bore hole in the present case. An upper end section of each support section 26 forms a force introduction point 25 for introducing forces and torques from the torsion bearing unit 30 into the base plate 20.

In the present case, the base plate 20 is assembled from several parts which are joined along dividing lines 28, 29. To simplify the assembly of the main bearing 23, a horizontal line 28 runs at the level of the main bearing 23 and intersects the rotor shaft axis 70. As a result, the main bearing section 22 has the configuration of a bearing bridge. Furthermore, the entire main bearing section 22 is joined to the rest of the base plate 20 by a further horizontal dividing line 28, which runs below the bore for the main bearing 23. This allows the main bearing section 22 to be manufactured and machined separately. To simplify assembly, the lower section of the base plate 20 is joined along two vertical dividing lines 29. The vertical dividing lines 29 run vertically and intersect the rotor shaft axis 70. The two halves of the base plate 20 on both sides of the rotor shaft axis 70 can thus be manufactured separately and joined afterwards. In a further embodiment, additional vertical dividing lines, for example two additional vertical dividing lines, are distributed around the circumference of the base plate 20.

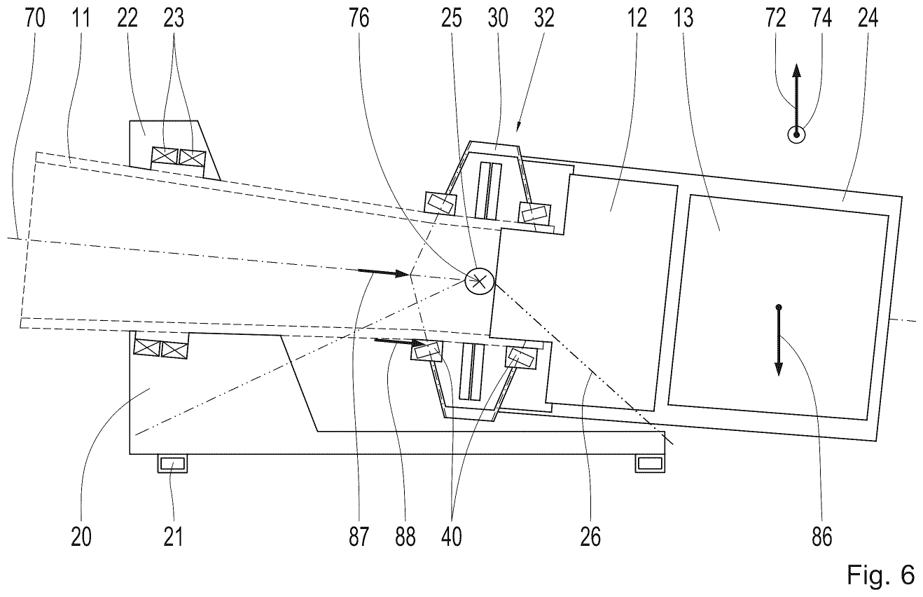

FIG. 6 schematically shows a bearing arrangement according to a first embodiment. The bearing arrangement is shown in a side sectional view along the rotor shaft axis 70. For better understanding, the vertical direction 72 and the transverse direction 74 are also shown as examples next to the rotor shaft axis 70. The base plate 20 is attached to the yaw bearing 6 and thus to the tower 2 by a base plate bearing 21. The base plate bearing 21 is configured as a rotationally symmetrical bearing element and, when the yaw bearing 6 is locked, transfers all degrees of freedom of the base plate 20 to the tower 2. In the present case, the main bearing 23 is configured as a radial bearing, which allows the rotation of the rotor shaft 11 and the axial displacement of the rotor shaft 11. On the other hand, the main bearing 23 absorbs radial forces of the rotor shaft 11, i.e., forces in the vertical direction 72 and forces in the transverse direction 74. Furthermore, the main bearing 23 absorbs a yaw moment about a yaw axis which runs through a center point of the main bearing 23 in the vertical direction 72.

The bearing housing 24 is attached to the torsion bearing unit 30, in this case screwed. The bearing housing 24 accommodates in this case the gearbox 12 and the generator 13. The torsion bearing unit 30 is supported at the force introduction point 25 by the support section 26. The support section 26 is shown in FIG. 6 simply as a dash-double-dot line. The torsion bearing unit 30 is supported by the support section 26 in such a way that the torsion bearing unit 30 is rotatable about a support axis 76. The support axis 76 runs through the force introduction point 25 in the transverse direction 74.

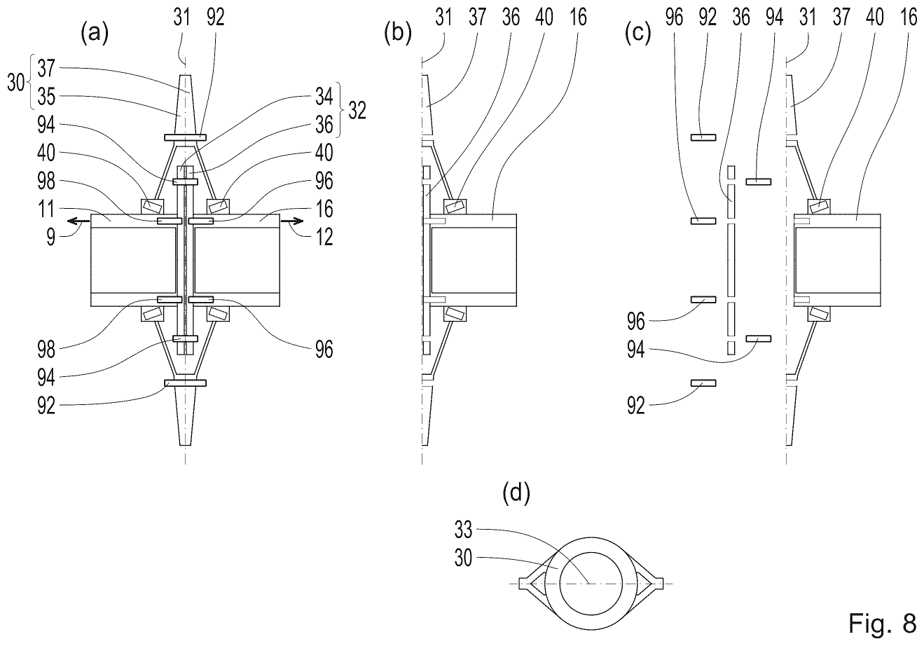

In the present embodiment, the rotor shaft 11 is rotatably supported in the torsion bearing unit 30 by two radial-axial bearings 40. The radial-axial bearings 40 are configured as angular contact roller bearings in the present case. In the present embodiment, the radial-axial bearings 40 of the torsion bearing unit 30 provide an angled bearing arrangement for the rotor shaft 11. In the present case, the angled bearing arrangement is in an O-arrangement, which is illustrated by a dash-dot line in FIG. 6. The rotor shaft 11 is mechanically operatively connected to the gearbox 12 via a connecting device 32, which will be described later with reference to FIG. 8.

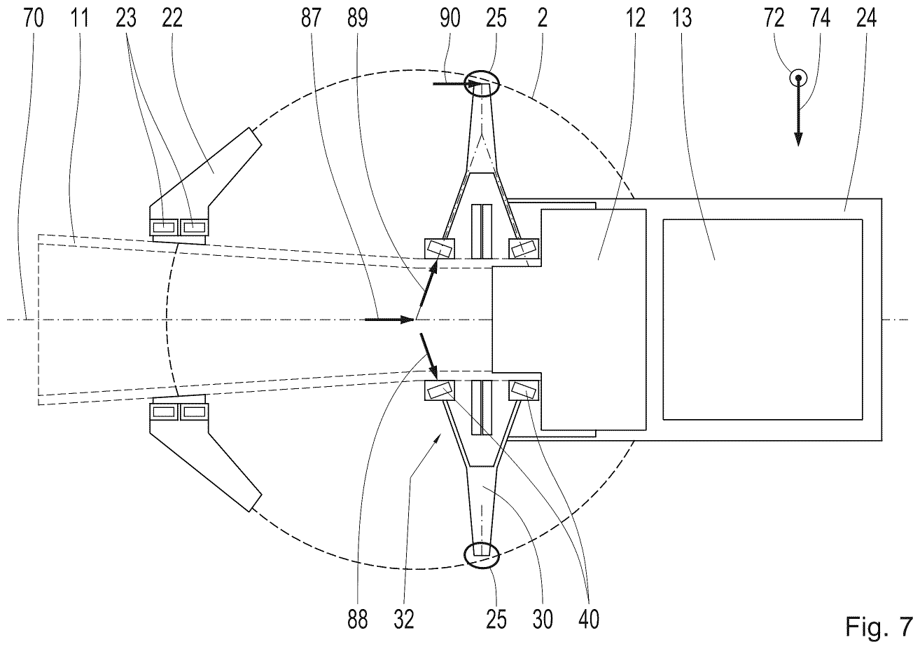

With reference to FIGS. 6 and 7, the introduction of axial forces from the rotor shaft 11 to the torsion bearing unit 30 and the base plate 20 will now be described. FIG. 7 is a schematic sectional view of the bearing arrangement of FIG. 6, viewed from above along the vertical direction. As shown in FIG. 7, an axial force 87, which is applied by the rotor shaft 11 in the direction of the gearbox 12 is divided into two axial force components 89 by the angled bearing arrangement. In accordance with the angled bearing arrangement, these axial force components 89 run at an oblique angle relative to the rotor shaft axis 70. At least one axial portion 90 of the respective axial force component 89 is introduced into the base plate at the force introduction point 25. Since the bearing arrangement and the load conditions are symmetrical in the top view of FIG. 7, these relationships apply to the force introduction points 25 on both sides of the rotor shaft axis 70, namely the upper side and the lower side in FIG. 7. On the other hand, the load conditions in the illustration of FIG. 6 are not symmetrical, since the weight force 86 of the bearing housing 24 acts downward and thus causes a one-sided bearing load. However, the angled bearing arrangement provided by the radial-axial bearings 40 is configured in such a way that a proportional axial force 88 runs below the rotor shaft axis 70 and to the left of the support axis 76 in the illustration of FIG. 6. Thus, this proportional axial force 88 counteracts a moment around the support axis 76, caused by the weight force 86 of the bearing housing 24.

FIG. 8 illustrates the disassembly of the connecting device 32 and the torsion bearing unit 30 according to the first embodiment. In area (a) of FIG. 8 the assembled state of the torsion bearing unit 30 and the connecting device 32 is shown. In the present case, the torsion bearing unit 30 and the connecting device 32 are detachably fastened to each other in a dividing plane 31. The dividing plane 31 runs between the rotor 4 and the gearbox 12 and perpendicular to the rotor shaft axis 70. In the present case, the rotor shaft 11 is located on one side of the dividing plane 31 and the gearbox 12 is located on the other side of the dividing plane 31.

The torsion bearing unit 30 can be divided along the dividing plane 31 into a rotor-side torsion bearing unit section 35 and a gearbox-side torsion bearing unit section 37. The connecting device 32 is divisible along the dividing plane 31 into a rotor shaft section 34 and a gearbox section 36. The rotor shaft section 34 is mechanically operationally connectable to the rotor shaft 11. The gearbox section 36 is mechanically operationally connectable to the gearbox 12. In the present case, the gearbox section 36 is connectable to a gearbox element 16, in this case a planetary carrier, in order to introduce the torsional moment of the rotor shaft 11 into the gearbox 12 via the gearbox element 16. The rotor shaft 11 and the rotor shaft section 34, the gearbox element 16 and the gearbox section 36, the torsion bearing unit sections 35, 37 among each other, as well as the rotor shaft section 34 and the gearbox section 36 among each other are each detachably fastened to each other, in this case via fasteners 92, 94, 96, 98. The fasteners 92, 94, 96, 98 are configured as screw connections.

By detaching the fasteners 92, 94, 96, 98, all gearbox-side components can be removed from the rotor-side components with reference to the dividing plane 31. The gearbox-side components are shown in an area (b) of FIG. 8. The gearbox-side components in the disassembled state are shown in the area (c) of FIG. 8. In the present case, for disassembly, first the fasteners 92 connecting the torsion bearing unit sections 35, 37 are first detached. Then the fasteners 94 connecting the rotor shaft section 34 to the gearbox section 36 are detached. Depending on the configuration of the torsion bearing unit sections 35, 37 with regard to accessibility to the fasteners 94, it may be necessary to remove at least one of the torsion bearing unit sections 35, 37. After detaching the fasteners 94, the respective components on one side of the dividing plane 31 can be removed from the components on the other side of the dividing plane 31. This allows the connection between the rotor shaft 11 and the rest of the drivetrain 10, for example the gearbox 12, to be disconnected, for example for maintenance work. After removal, the fasteners 96 for fastening the gearbox section 36 to the gearbox element 16 can be detached. Similarly, the fasteners 98 for fastening the rotor shaft section 34 to the rotor shaft 11 can be detached. This allows the torsion bearing unit 30 and the connecting device 32 to be easily disassembled. In the present case, the torsion bearing unit 30 is divisible along a further horizontal dividing plane 33, so that only part of the torsion bearing unit 30 needs to be removed for access to the fasteners 94.

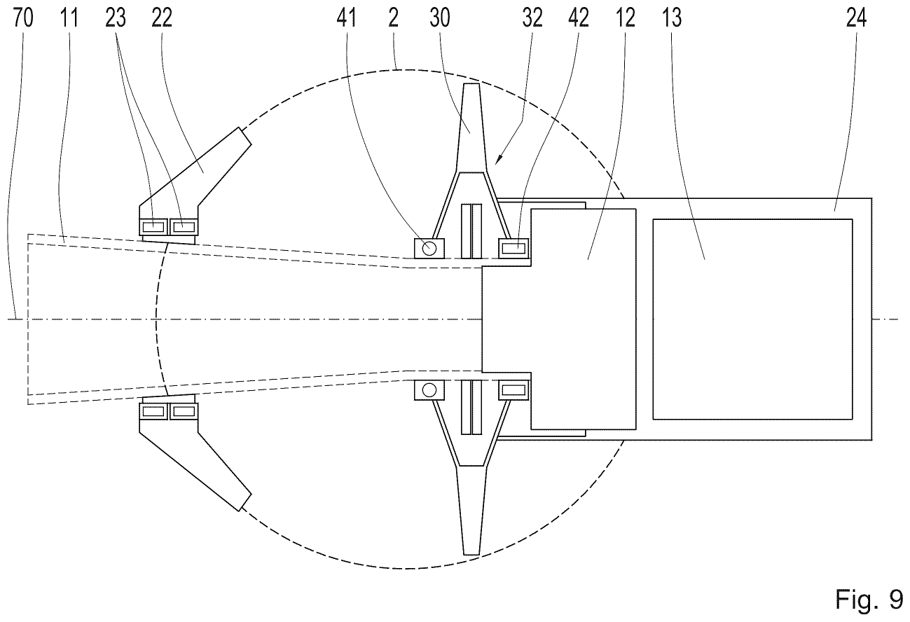

FIG. 9 is a schematic sectional view of a bearing arrangement according to a second embodiment. Only the differences from the first embodiment of FIGS. 6 to 8 are explained. In the second embodiment, the torsion bearing unit 30 for supporting the rotor shaft 11 has a radial-axial bearing 41 and a radial bearing 42. Thus, instead of the angled bearing arrangement of the first embodiment, a fixed-loose bearing arrangement is provided. The radial-axial bearing 41 absorbs both radial forces and axial forces from the rotor shaft 11. The radial-axial bearing 41 is in the present case configured as a ball roller bearing. The radial bearing 42 does not absorb any axial forces. The present radial bearing 42 is configured as a cylindrical roller bearing.

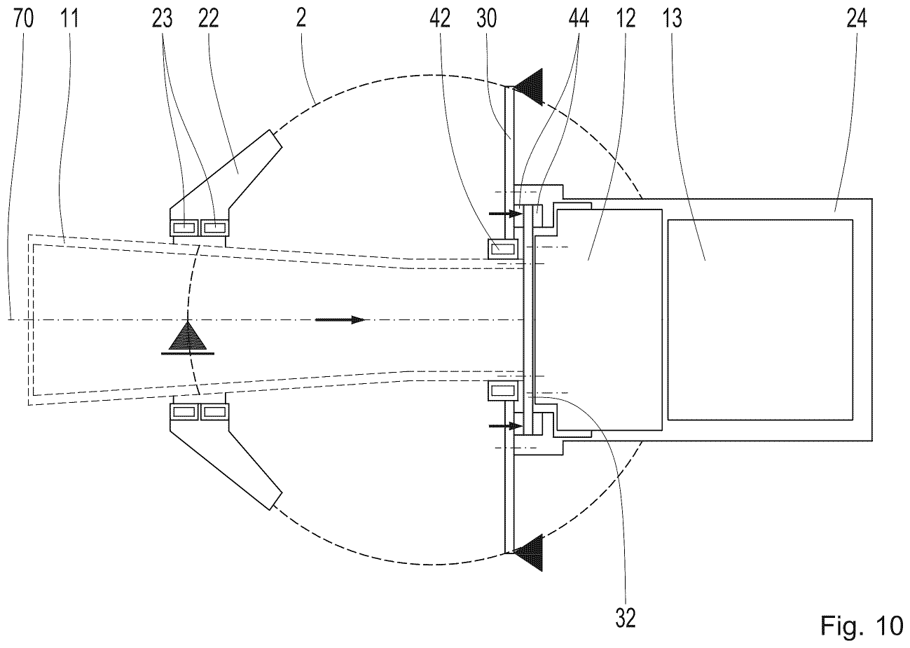

FIG. 10 is a schematic sectional view of a bearing arrangement according to a third embodiment. Only differences from the first embodiment of FIGS. 6 to 8 are explained. In the bearing arrangement according to the third embodiment, the torsion bearing unit 30 has a radial bearing 42 and an axial bearing 44. The radial bearing 42 only absorbs radial forces from the rotor shaft 11 and in the present case is configured as a rolling bearing, more specifically a cylindrical roller bearing. The axial bearing 44 is here configured to support axial forces from the rotor shaft 11 in both axial directions along the rotor shaft axis 70. The axial bearing 44 is configured as a friction bearing. More specifically, the axial bearing 44 has two halves that are configured as ring-shaped bearing components and absorb the axial forces from the connecting device 32 on both axial sides of the connecting device. This is illustrated for one direction in FIG. 10 by arrows parallel to the rotor shaft axis 70. In the present embodiment, the axial bearing 44 is configured to extend around the entire circumference of the rotor shaft 11. In a further embodiment, the axial bearing 44 is only provided in sections along the circumference of the rotor shaft 11.

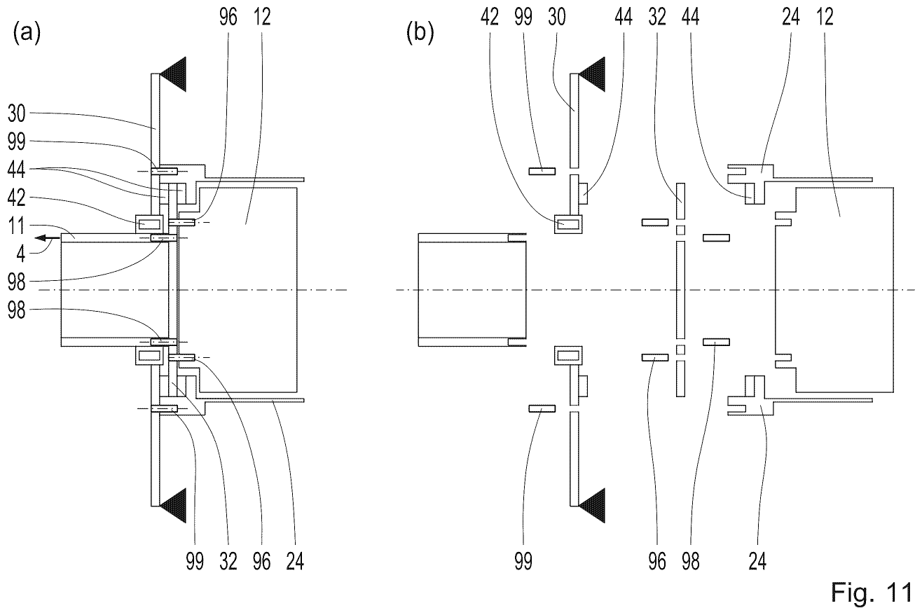

Furthermore, in the third embodiment, the dividing plane 31 is not provided, so that the torsion bearing unit 30 and the connecting device 32 are not divided for disassembly. This is described below with reference to FIG. 11. As can be seen in area (a) on the left side of FIG. 11, both the torsion bearing unit 30 and the connecting device 32 are configured as disk-shaped elements. This eliminates the need for screw connections with fasteners 92 and 94. In the third embodiment, the bearing housing 24 is fastened to the torsion bearing unit 30. As part of this fastening, in the present embodiment, the connecting device 32 is clamped between both sides of the axial bearing 44. In this embodiment, the bearing housing 24 is fastened to the torsion bearing unit 30 using fasteners 99, which in this case are configured as screw connections. As in the first embodiment, the rotor shaft 11 is fastened to the connecting device 32 via fasteners 98. The gearbox 12 is fastened to the connecting device 32 via fasteners 96 (the gearbox element 16 of the first embodiment is not shown here). Since the two-part configuration of the connecting device 32 of the first embodiment is not provided in the third embodiment, the fasteners 96 are provided on a larger pitch circle diameter than the fasteners 98 for the purpose of accessibility. In addition, the fasteners 96 do not overlap the rotor shaft 11. This ensures access to the fasteners 96 for removing the connecting device 32 from the gearbox 12.

In area (b) on the right-hand side of FIG. 11 the disassembled state of the torsion bearing unit 30 and the connecting device 32 is shown. For disassembly, the fasteners 99, the fasteners 96, and the fasteners 98 are detached in this order. Accordingly, the radial bearing 42 and one half of the axial bearing 44 remain attached to the torsion bearing unit 30, while the other half of the axial bearing 44 remains attached to the bearing housing 24.

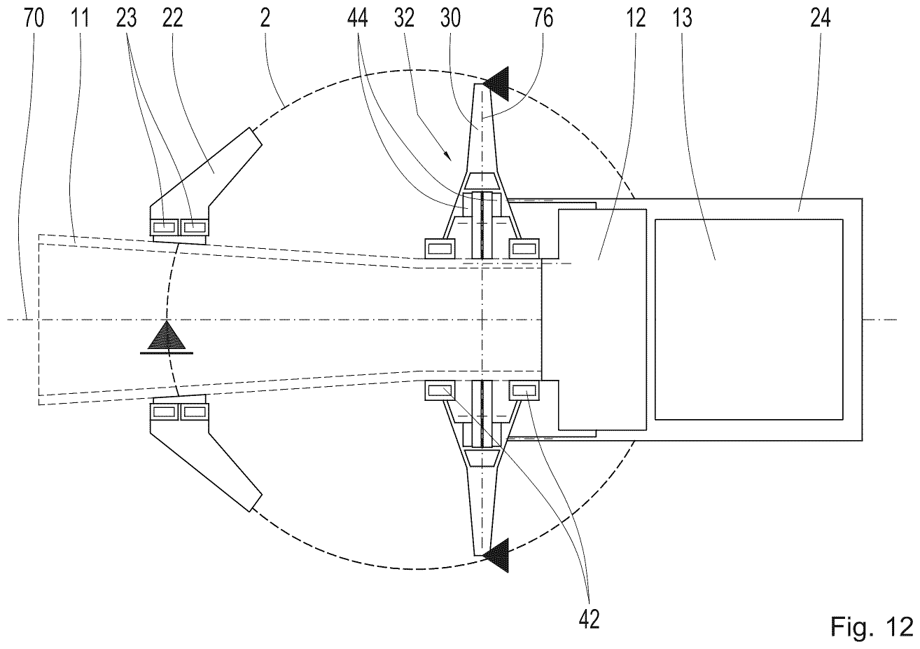

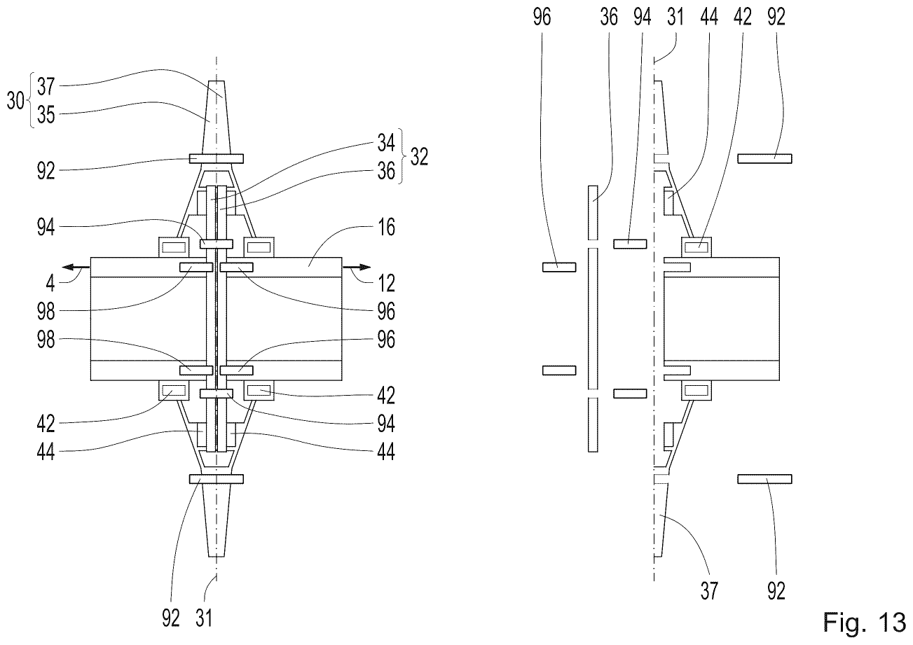

FIG. 12 is a schematic sectional view of a bearing arrangement according to a fourth embodiment. Only differences from the first embodiment of FIGS. 6 to 8 are explained. In the fourth embodiment, the torsion bearing unit 30 has two radial bearings 42 and one axial bearing 44. In the present case, the two radial bearings 42 are arranged symmetrically to the support axis 76. In addition, the two radial bearings 42 are provided as identical parts in this case. The torsion bearing unit 30 and the connecting device 32 are divisible, as in the first embodiment. As in the third embodiment, the connecting device 32 is axially supported by clamping the connecting device 32 between two halves of the axial bearing 44. FIG. 13 is an illustration of a disassembly of the connecting device 32 and the torsion bearing unit 30 according to the fourth embodiment. As can be seen from a synopsis of FIG. 8 and FIG. 13, the disassembly in the fourth embodiment can be carried out in almost the same way as in the first embodiment. Differing from this, in the fourth embodiment, after disassembly, one half each of the axial bearing 44 remains in the rotor shaft section 35 and the gear section 37.

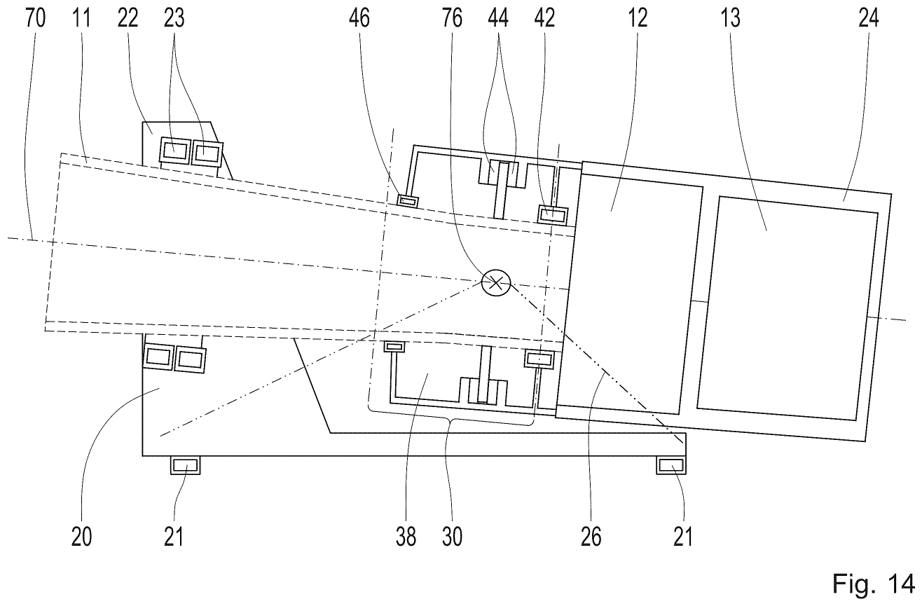

FIG. 14 schematically shows a bearing arrangement according to a fifth embodiment in a side sectional view as in FIG. 6. Only differences from the fourth embodiment of FIG. 12 are explained. In the fifth embodiment, the torsion bearing unit 30 has a radial bearing 42 and a further radial bearing 46. The radial bearing 42 is arranged closer to the support axis 76 along the rotor shaft axis 70 than the further radial bearing 46. Accordingly, the radial bearing 42 absorbs a larger proportion of the forces and torques to be introduced into the base plate 20 via the support section 26. The further radial bearing 46 can thus be dimensioned smaller than the radial bearing 42. The further radial bearing 46 therefore primarily serves to align the torsion bearing unit 30 and the bearing housing 24 at the bend of the rotor shaft 11. In addition, as in the fifth embodiment, the torsion bearing unit 30 is configured with the same diameter as the bearing housing 24. Furthermore, the torsion bearing unit 30 has a lubricant reservoir 38 in which lubricant, for example for the gearbox 12, is stored.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE MARKINGS

1 wind turbine
2 tower
3 nacelle
4 rotor
5 base
6 Yaw bearing
10 drivetrain
11 rotor shaft
12 gearbox
13 generator
14 auxiliary units
15 hub
16 gearbox element
20 base plate
21 base plate bearing
22 main bearing section
23 main bearing
24 bearing housing
25 force introduction point
26 support section
27 recess
28, 29 dividing line
30 torsion bearing unit
31, 33 dividing plane
32 connecting device
34 rotor shaft section
35, 37 torsion bearing unit section
36 gearbox section
38 lubricant reservoir
40, 41 radial-axial bearing
42, 46 radial bearing
44 axial bearing
70 rotor shaft axis
72 vertical direction
74 transverse direction
76 support axis
80 support torsional moment
82 support for other rotor shaft loads
84, 86 weight force
87, 88 axial force
89 axial force component
90 axial portion
92, 94, 96, 98, 99 fasteners

What is claimed is:

1. A bearing arrangement for a wind turbine for supporting a drivetrain on a tower of the wind turbine, comprising:
a base plate which is attachable to the tower and has a main bearing section for rotatably supporting a rotor shaft of the drivetrain and for supporting forces of the rotor shaft;
a bearing housing for receiving and supporting parts of the drivetrain; and
a torsion bearing unit for supporting a torsional moment about a rotor shaft axis applied by the drivetrain to the bearing housing,
wherein the main bearing section is configured to introduce radial forces into the base plate with respect to the rotor shaft axis and to allow axial displacements along the rotor shaft axis,
wherein the radial forces have components in a transverse direction and components in a vertical direction, and
wherein the torsion bearing unit is configured to introduce axial forces in a direction of the rotor shaft axis and torsional moments about the rotor shaft axis into the base plate.

2. The bearing arrangement according to claim 1, wherein the base plate has a support section which is configured to support the torsion bearing unit rotatably about a support axis extending in the transverse direction.

3. The bearing arrangement according to claim 1, wherein the torsion bearing unit for supporting the rotor shaft has an angled bearing arrangement with two radial-axial bearings which transmit radial and axial forces respectively.

4. The bearing arrangement according to claim 1, wherein the torsion bearing unit for supporting the rotor shaft has a radial-axial bearing and a separate radial bearing.

5. The bearing arrangement according to claim 2, wherein the torsion bearing unit for supporting the rotor shaft has a radial bearing and a separate axial bearing.

6. The bearing arrangement according to claim 5, wherein the torsion bearing unit for supporting the rotor shaft has a further radial bearing, and the radial bearing and the further radial bearing are arranged symmetrically about the support axis.

7. The bearing arrangement according to claim 5, wherein the torsion bearing unit for supporting the rotor shaft has a further radial bearing, and the further radial bearing is further spaced from the support axis than the radial bearing.

8. The bearing arrangement according to claim 1, wherein the bearing arrangement has a connecting device which has a rotor shaft section which is connectable in a rotationally fixed manner to the rotor shaft, and a gearbox section which can be connected in a rotationally fixed manner to a gearbox of the drivetrain.

9. The bearing arrangement according to claim 8, wherein at least one of the rotor shaft section and the gearbox section is arranged in a force flow for introducing axial forces from the rotor shaft into the torsion bearing unit.

10. The bearing arrangement according to claim 1, wherein the torsion bearing unit has a lubricant reservoir.

11. The bearing arrangement according to claim 1, wherein the base plate is configured as a shell element that essentially follows a cylindrical surface.

12. The wind turbine with the drivetrain, the tower, and the bearing arrangement according to claim 1, which is attached to a tip of the tower.

13. The wind turbine according to claim 12, wherein a force introduction point for introducing forces from the torsion bearing unit into the base plate overlaps a tip-side wall of the tower in the vertical direction.
